(19) United States
(12) Patent Application Publication
(10) Pub. No.: US 2025/0251767 A1
(43) Pub. Date: Aug. 7, 2025

(54) COMPUTER IMPLEMENTED METHOD OF MONITORING POWER AND ADJUSTING COMPONENT PERFORMANCE

(71) Applicant: Hewlett Packard Enterprise Development LP, Spring, TX (US)

(72) Inventors: Eitan Frachtenberg, Portland, OR (US); Cullen E. Bash, Milpitas, CA (US); Torsten Wilde, Berlin (DE)

(21) Appl. No.: 18/433,920

(22) Filed: Feb. 6, 2024

(51) Int. Cl. G06F 1/26; G06F 1/28

(52) U.S. Cl. CPC G06F 1/263; G06F 1/28

(57) ABSTRACT

In an example implementation consistent with the features disclosed herein, a computer-implemented method includes monitoring power available to a plurality of nodes. Each node corresponding to an electronic component, device, or group of devices. The method includes detecting that the power available to the nodes is outside a power range within which all of the nodes can operate at a full operation level. When the power available to the node is outside the power range, allocation of the available power amongst the nodes is determined and at least some of the nodes are signaled to transition to a mode that utilizes less power.

### BACKGROUND

A data center is a dedicated space, e.g., a building, a portion of a building, or a group of buildings, used to house computer systems and associated components, such as telecommunications and storage systems. A data center typically includes redundant or backup components and infrastructure for power supply, data communication connections, environmental controls (e.g., air conditioning, fire suppression), and various security devices.

Data centers operate more efficiently when provided with a reliable and continuous power supply. Data centers powered by renewable power sources, such as solar and wind, may experience fluctuations in generated power and available power, for example, less power may be produced with solar panels on a cloudy day. In addition, data centers may experience power generation fluctuation from power producers that are unable to supply enough power to meet demands.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1A illustrates a block diagram of a device or system for reactive compute power, according to some implementations;

FIG. 1B illustrates a block diagram of one implementation of the system for reactive compute power illustrated in FIG. 1A;

FIG. 1C illustrates a block diagram of another implementation of the system for reactive compute power;

FIG. 2 illustrates a method for reactive compute power, according to some implementations;

FIG. 3 illustrates a diagram representing power ranges, operation levels, and corresponding thresholds of power available, according to some implementations;

FIG. 4 illustrates a flowchart of a method for providing reactive compute power in a data center, according to some implementations

FIG. 5 illustrates a block diagram of a system for reactive compute power, according to some implementations;

FIG. 6A-6B illustrates a method for reactive compute power, according to some implementations;

FIG. 7 illustrates a method for reactive compute power, according to some implementations;

FIG. 8 illustrates a flowchart of a method for reactive compute power, according to some implementations; and

FIG. 9 illustrates a system for reactive computer power, according to some implementations.

### DETAILED DESCRIPTION OF ILLUSTRATIVE EMBODIMENTS

The following disclosure provides many different examples for implementing different features. Specific examples of components and arrangements are described below to simplify the present disclosure. These are, of course, merely examples and are not intended to be limiting.

Data centers experience an increasing need for power. Outages and interruptions in power can be disruptive and expensive for data centers. Server racks in data centers may be powered through a combination of electrical systems designed to provide reliable and uninterrupted power. For example, data centers may be connected to a local power grid that receives electricity from a power provider. Power providers may include power generated from natural gas, coal, nuclear, solar, tide, and wind. The power provider could comprise a microgrid that can include, for example, fuel cells and other sources. Microgrids could be used as primary power sources (e.g., with the grid as a backup) or, as discussed below, as backup sources. Data centers may experience fluctuations in power generation from power providers as well as variability in power availability from renewable power resources. The fluctuations and variability require expensive storage or overprovisioning solutions to meet the computing equipment's power requirements for stable voltage and current.

Power distribution units (PDUs) may distribute power from the power provider to server racks within data centers. Each individual server or computing unit within the server or server rack may be referred to as a node. Nodes within the server rack refer to and include, but are not limited to, compute nodes, storage nodes, networking nodes, and specialized nodes. Compute nodes may handle computation tasks, run applications, and perform various computing functions. The compute nodes may correspond to electronic components responsible for computing tasks. The nodes may vary in configuration, processing power, memory, and storage capacity. In accordance with some implementations, a node may be formed from all or part of an actual physical machine and the node may include and/or correspond to one or more virtual components or virtual environments of a physical machine.

To promote efficient power distribution in the event of power fluctuations, computing equipment may adjust performance, potentially undesirably, to consume less power. For example, when available power decreases, the computing equipment can react by slowing down to consume less power, thereby increasing power efficiency. As a particular example, when a power supply detects dropping voltage, a monitor/controller may communicate with a CPU to throttle down and reduce the workload. On the other hand, when available power increases, the computing equipment may accept additional workloads or speed up processes.

Computing equipment may also react in advance to prepare for reduced power availability. For example, when power demands are greater than available power generated, the computing equipment may receive a signal to complete pending tasks and prepare to suspend a corresponding node in anticipation of the reduced power availability. The task may be arranged by priority, where nodes corresponding to low-priority tasks prepare to suspend their tasks while nodes corresponding to high-priority tasks continue to operate with the remaining available power.

Certain embodiments provide a power controller module that detects an amount of power supplied to a node that corresponds to an electronic component. The power controller module detects when the available power is outside of a normal range (e.g., the normal range being the power required according to the specification of the electronic component) and determines whether the available power is outside of a tolerance (e.g., the tolerance being the minimum amount of power required according to the specification of the component). When the available power is outside of the normal range and outside of tolerance, the power controller module instructs the electronic components to adjust the performance of the components at each node. The electronic components may, for example, adjust their performance by suspending tasks or by hibernating until the normal range of power, or at least power within the tolerance, is restored.

Certain embodiments provide a system operation optimization manager that monitors an amount of power supplied to multiple nodes. The nodes may include a rack, row, or cluster of servers. The system operation optimization manager is configured to receive a signal from a power provider and to coordinate with a job scheduler to prepare to react to expected changes in available power. In the event of reduced available power, the job scheduler is configured to prioritize the jobs among the nodes and apply a power cap to the rack, row, or cluster corresponding to low-priority jobs. A power controller module instructs the electronic components corresponding to the nodes of the low-priority jobs to adjust the performance of the components. The electronic components may, for example, adjust their performance by suspending tasks or by hibernating until the normal range of power is restored. The reduced available power may be redistributed to the nodes of high-priority jobs.

Certain embodiments of this disclosure may reduce or eliminate reliance on expensive power storage solutions handling fluctuations in power availability from renewable power sources. Certain embodiments may reduce or eliminate reliance on over-provisioning solutions to meet the equipment's power requirements for stable voltage and current. In the face of fluctuations in available power (e.g., as may be a consequence of attempting to increase reliance on certain renewable power sources), certain embodiments may reduce or eliminate attempts to meet the compute equipment power requirements and instead allowing the equipment and workload to react gracefully to available power. Certain embodiments may provide operational and economic efficiency, such as by reducing energy cost by exploiting more renewable power when available, increasing opportunistic throughput in datacenters when power is abundant, and providing a competitive advantage when integrated with modern elastic workloads. Certain embodiments may allow more entities to host on-premises hardware in locations that were previously untenable due to lack of predictable power. Certain embodiments may allow more datacenter locations that comply with increasing environmental regulations. Certain embodiments may use more renewable energy sources, which may accelerate an entity's shift to net-zero greenhouse gas emissions. Certain embodiments may allow the placement of edge data centers close to renewable energy sources where power generation is variable, potentially acting as a power sink in phases of low demand or excess power generation.

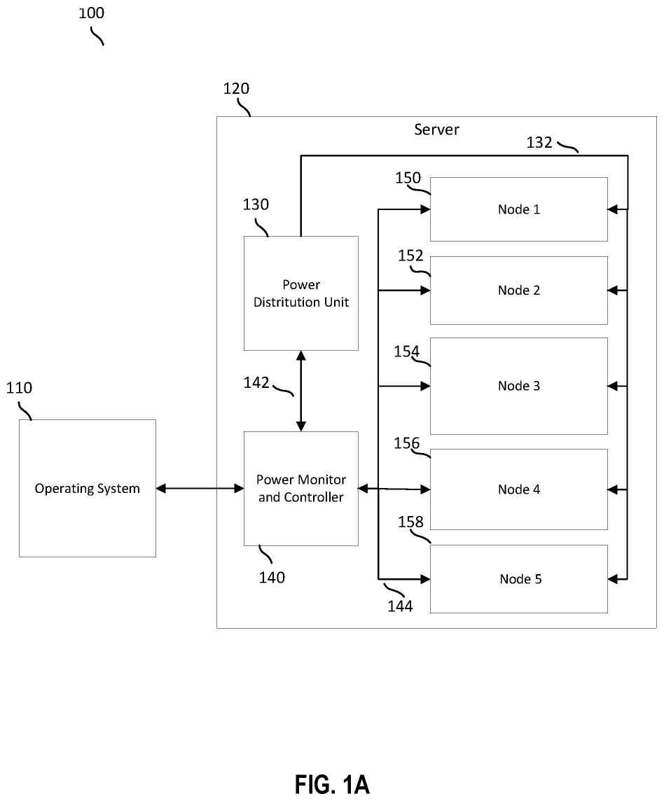

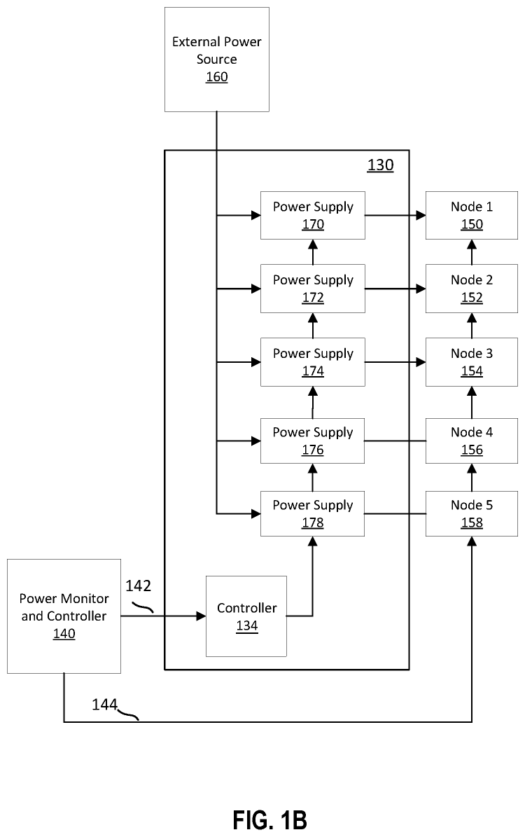

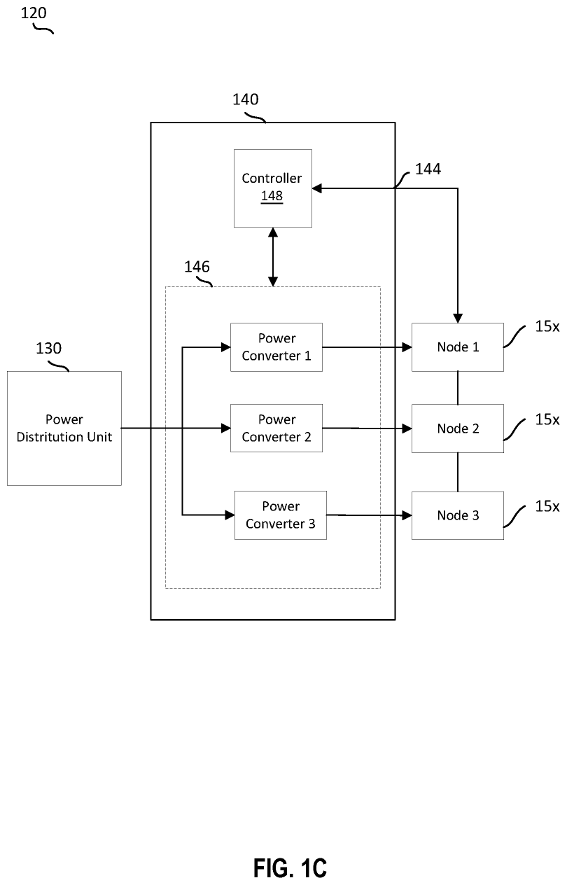

FIG. 1A illustrates a block diagram of a system 100 for reactive compute power, according to some implementations while FIG. 1B and FIG. 1C illustrate block diagrams of two more specific implementations. These three figures are collectively referred to as FIG. 1. As discussed below, the concepts discussed herein are not limited to the particular implementations shown in FIG. 1.

Referring to FIG. 1A, the system 100 includes an operating system 110 and a server 120. While illustrated in different boxes, it is understood that the components shown in FIG. 1A can be distributed in different components. In other words, the boxes shown in the figure should not be construed to limit which components are in different housings or at different locations. In other words, this disclosure contemplates system 100 including any suitable components in any suitable arrangement.

The operating system 110 manages hardware resources of the server 120 include various tasks such as process management, memory management, file system management, and input/output operations. The operating system 110 can be implemented with a computer device that provides operating instructions to the server 120 to manage the hardware and software resources of the server. This function can be performed by a single processor or distributed over a number of processors, which may be co-located or remote from one another. The operating system can be located in the same housing as the server 12 (e.g., using common processor(s)) or a different housing.

The server 120 may include a power distribution unit or power supply 130, a power monitor and controller 140, and nodes 150, 152, 154, 156, 158 (generically referred to as 15x). The nodes 15x may be electronic components including, for example, a central processing unit (CPU) power, a random access memory (RAM) power, motherboard cooling control, or server cooling control. It is understood that server may have more than one of each associated with corresponding nodes. It is also understood that a given system may include a subset of these components, entirely different components, as well as other electronic components. For example, other components can include storage devices, networking devices (including so-called smart storage and smart NIC (network interface controller) which have their own processors and memory), and various accelerators such as GPUs (graphics processing units) and FPGAs (field programmable gate arrays), as examples.

The power distribution unit 130 is configured to receive input power from a power grid, microgrid, backup power sources, and similar via a connection that is not illustrated (see FIG. 1B). The power distribution unit 130 may be configured to distribute the input power to components of the server 120 and real-time power metrics to the power monitor and controller 140. The power distribution unit 130 can include one or more power supplies or power converters to supply electric power to the components 15x (again see FIG. 1B).

The power monitor and controller 140 can be implemented to determine the power levels to each of the nodes 15x based on available power and performance requirements of each node 15x. Specific implementations are discussed in further detail below. The power monitor and controller 140 may be implemented as hardware in a CPU or motherboard, firmware in a CPU or motherboard, or software at the operating system level.

The nodes 15x are configured to receive power from the power distribution unit 130 via power bus 132. The nodes 15x may perform various computational tasks and execute applications within the computing environment. For example, node 150 may handle processing tasks including executing instructions, running programs, and performing computations using a central processing unit (CPU). As another example, node 152 may manage data storage and data retrieval utilizing random-access memory within the server 120. Other examples include nodes 154 and 156 which may provide cooling control by utilizing a motherboard cooling control and server cooling control.

The power monitor and controller 140 communicates with the power distribution unit 130 and nodes 15x via control lines 142, 144 to determine how power should be distributed and to control operation of the nodes 15x. For example, the power monitor and controller 140 can adjust operation of the electronic components of the nodes 15x by controlling parameters such as clock speeds (e.g., a CPU clock speed, a RAM clock speed) voltage parameters, current parameters, and cooling parameters as just some examples.

FIG. 1B illustrates a block diagram of an example implementation. In this figure, the power distribution unit 130 receives power from an external power source 160. The external power source 160 can be any source or combination or sources that supply power to the server 120. The power source 160 can be a power grid powered by a power plant, driven by any energy source. Alternatively, or in combination, the power source can be a so-called renewable energy source such as those powered by solar, wind, or water. A microgrid could also be used as the primary power source 160.

The power distribution unit 130 in the example shown in FIG. 1B includes a number of power supplies (e.g., power converters, power regulators) 170, 172, 174, 176, 178 (generically 17x). Each power supply 17x receives power directly or indirectly from power source 160 and converts the power to a level that is suitable for each node based on control information provided to controller 134 by power monitor and controller 140. The power monitor and controller 140 in turn controls operation of the associated node 15x to function with the supplied power though communication via signal bus 144.

As an example, the power distribution unit 130 determines that power provided by power source 160 is insufficient to operate all of the nodes 15x at full capacity. The power monitor and controller 140 can then determine the optimal operation of the various components based on the tasks being performed, signal to the power distribution unit as to how to distribute the available power among the nodes 15x, and control operation of the nodes 15x consistent with the power being received. For example, if the server 120 operation is computationally intense, a high power level can be provided to a CPU and memory can receive power, e.g., the CPU voltage is at a high level so that the clock speed can be maximized while the memory clock speed is lowered. On the other hand, if the server is performing a memory storage intense operation, the opposite can occur, that is the CPU clock speed is lowered and the memory allowed to operate at full speed.

FIG. 1C illustrates a block diagram of another example system. This example illustrates that the distribution of the components can vary. Referring to FIG. 1C, the server 120 again includes a power distribution unit 130 and a power monitor and controller 140, and a plurality of nodes 15x. In this implementation, the power monitor and controller 140 includes a controller 148 and a plurality of power converters 146. The power distribution unit 130 provides power to the plurality of power converters 146, which in turn power the corresponding nodes 15x. The controller 148 is configured to monitor the amount of power available from the power distribution unit 130, communicate with the plurality of nodes 15x via control lines 144 to determine the power needs, and control the power converters 146 to supply power to the plurality of nodes 15x as needed.

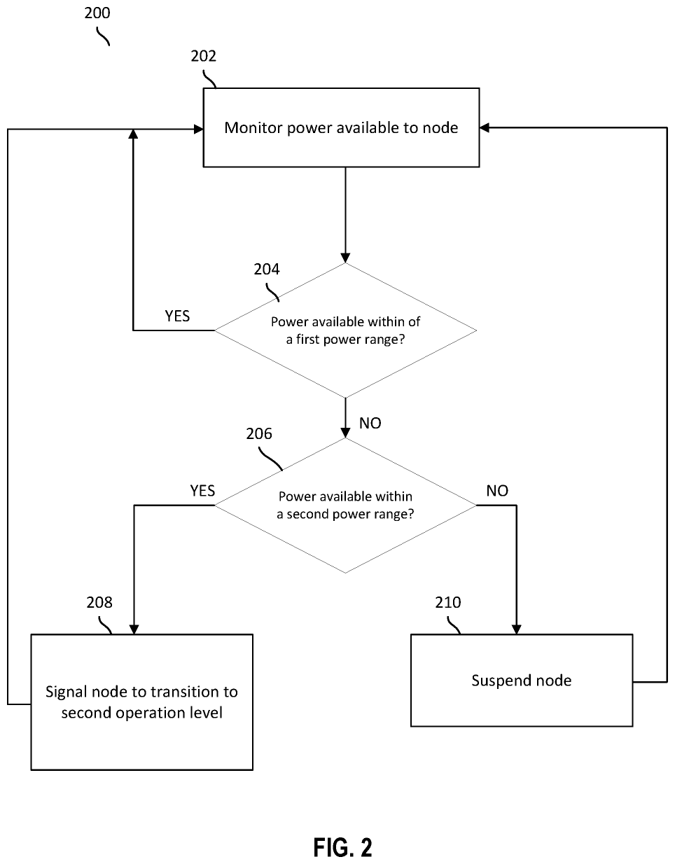

FIG. 2 illustrates a method for reactive compute power 200, according to some implementations. The method for reactive compute power 200 will be described in conjunction with FIGS. 1A and 1B. The method for reactive compute power 200 may be performed by the power monitor and controller 140 of the server 120, as an example. In step 202, the power monitor and controller 140 may continuously monitor the power available to each node 15x. The power available corresponds to an amount of power provided to the power distribution unit 130. As discussed above, the power available may include power generated from natural gas, coal, nuclear, solar, tide, and wind.

In step 204, the power monitor and controller 140 detects whether the power available to the node 15x is within a first power range. When power available is within a first power range, the node 15x may operate at a first operation level. The first power range is a range of power in which the electronic components may operate with full power, i.e., enough power so that the electronic components can operate without constraints due to power. The first operation level is a standard operation of the corresponding electronic components based on the voltage requirements of the electronic components. For example, the first operation level may be the operation level where optimal performance is possible. At this level, the power distribution unit 130 can provide a maximum amount of power that the node 15x can handle, for example, a single CPU in a server may require 300 to 400 watts. In this particular example, the first power range would be power above 400 watts.

When the power monitor and controller 140 detects that the power available is within the first power range, the power monitor and controller continues to monitor the power available to the node 15x. When the power monitor and controller 140 detects that the power available is outside the first power range in step 204, the power monitor and controller 140 determines whether the power available to the node 15x is within a second power range (step 206). The second power range is a range of power that includes a minimum power usage requirement based on the operating voltage and the voltage tolerance of the electronic components required to operate the node.

When the power available is within the second power range, the power monitor and controller 140 signals the node 15x to transition from the first operation level to a second operation level, as shown in step 208. In step 208, the power monitor and controller 140 sends a signal to the electronic component corresponding to the node 15x to transition to a second operation level to cause the electronic component to adjust its performance based on the power available. In some implementations, the second operation level may include operating in low power mode when the power available is within the minimum voltage tolerance. For example, a CPU may react to the node 15x operating in low power mode by throttling down and reducing the workload or declining work units. In other implementations, a motherboard cooling control, for example, may react to the node 154 operating in low power mode by reducing fan speeds.

When the power available is outside of the second power range, the power monitor and controller 140 may suspend the node, as shown in step 210. The power monitor and controller 140 may suspend the node by cutting off power supplied to the node 15x. By suspending the nodes, the corresponding electronic component will no longer be in operation without power being supplied to the node, although it may be in a sleep mode.

The power monitor and controller 140 continues to monitor the power available at the power distribution unit 130 to provide real time responses to changes in power. In some implementations, the power monitor and controller 140 may provide substantially instantaneous response to changes in power availability. In other implementations the power monitor and controller 140 may vary operations in periods of a response time as the power availability changes. The period will vary with the use case. Hardware-based systems (e.g., with no advanced info from a power provider) could be in micro second range, which is similar to an emergency response activity (e.g., going directly to the lowest possible power state). Software-based systems might react in 100 ms to 1 s range. Billing cycles can be as long as 15 min (if a power provider dynamically adjusts available power per billing cycle).

FIGS. 1A, 1B, 1C, and 2 illustrate and are described with respect to a single server. It should be appreciated, however, that multiple nodes across a plurality of servers may be monitored simultaneously.

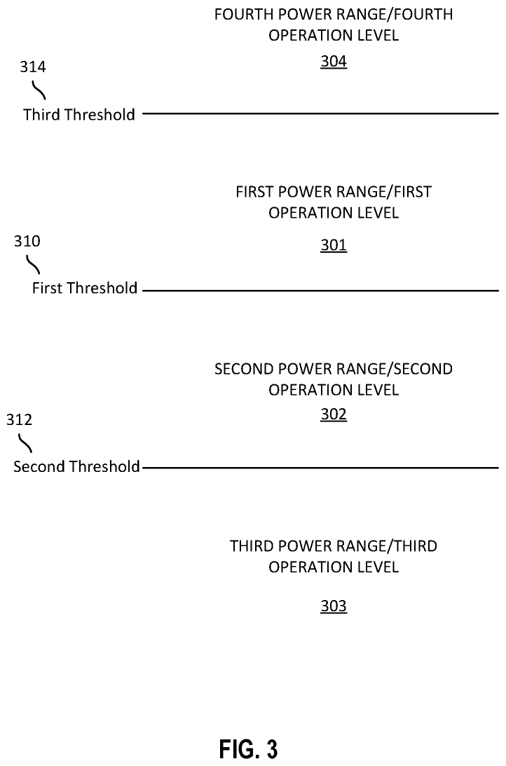

FIG. 3 illustrates a diagram 300 representing power ranges, operation levels, and corresponding thresholds of power available as described above. When power available to a node is above a first threshold 310 and below a third threshold 314, the power available is within a first power range 301 and the node operates at a first operation level. The first operation level associated is a normal operation of the electronic components based on the voltage requirements of the electronic components.

When power available to a node is below the first threshold 310 and above a second threshold 312, the power available is within a second power range 302 and the node operates at a second operation level.

When power available to a node is below a second threshold 312, the power available is within a third power range 303 and the node operates at a third operation level. The third operation level may include suspending pending tasks or hibernating.

When power available to a node is above the third threshold 314, the power available is within a fourth power range 304 and the node operates at a fourth operation level 304. The fourth operation level may include operating in a high power mode when the power available is within the maximum voltage tolerance but perhaps above a specification voltage level. For example, a CPU may operate in high power mode by overclocking thereby increasing the workload or accepting additional work units.

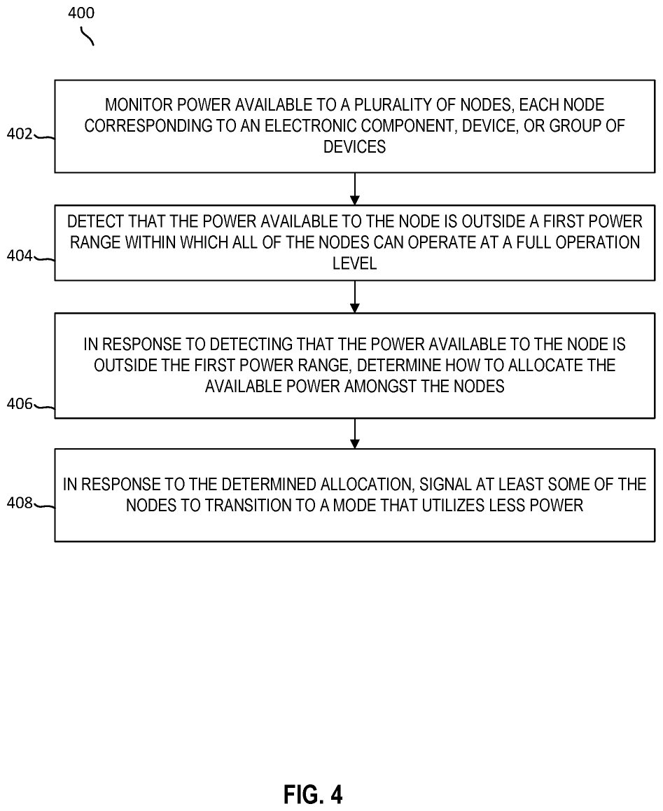

FIG. 4 illustrates a flowchart 400 of a method for providing reactive compute power, according to some implementations. The flowchart 400 of the method for providing reactive compute power will be described in conjunction with FIG. 1A-1C, FIG. 2, and FIG. 3. The method for providing reactive compute power described in flowchart 400 may be performed by the power monitor and controller 140 of the server 120.

In step 402, the power monitor and controller 140 monitors the power available to a node 15x. The nodes 15x operate at a first operation level. Each node 15x corresponds to an electronic component as described in FIG. 1, for example. In step 404, the power monitor and controller 140 detects that the power available to the node is outside a first power range within which the node operates at a first operation level as described above with respect to FIG. 2 and FIG. 3. In step 406, the power monitor and controller 140 determines, in response to detecting that the power available to the node is outside the first power range 301, whether the power available to the node is within a second power range 302 in which the power available is less than the power available in the first power as described above with respect to FIG. 2 and FIG. 3. In step 408, the power monitor and controller 140 signals the node to transition to a second operation level associated with a power level within the second power range 302 to cause the electronic component to adjust performance of the electronic component.

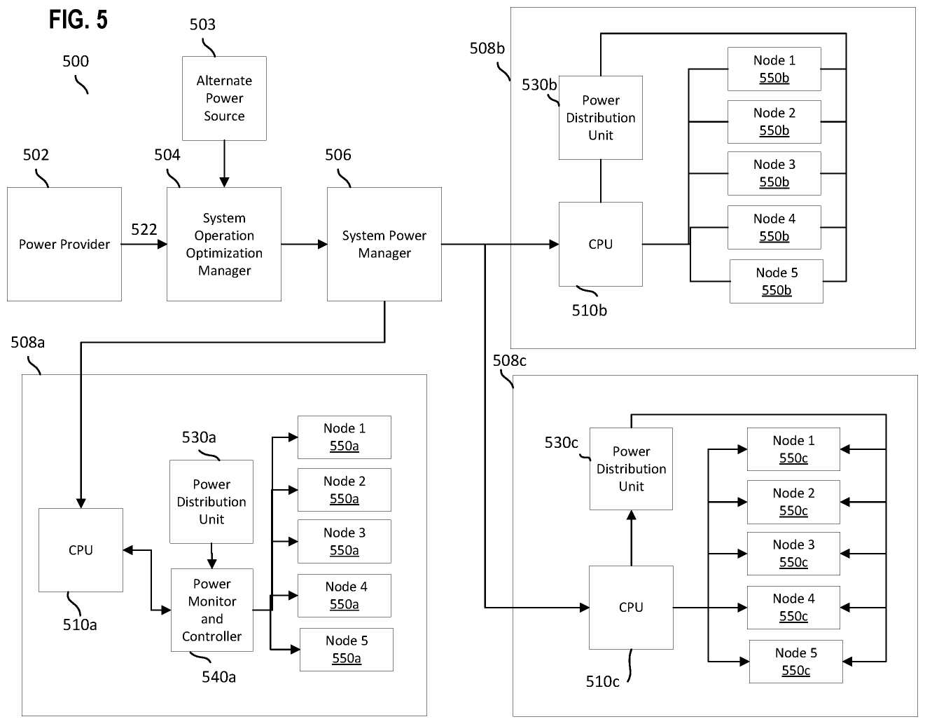

FIG. 5 illustrates a block diagram of a system 500 for reactive compute power, according to some implementations. Referring to FIG. 5, the system 500 includes a power provider or providers 502, alternate power source or sources 503, a system operation optimization manager 504, a system power manager 506, and multiple nodes 508a, 508b, 508c (generically referred to as 508). The nodes may be servers in a server rack, server racks in a data center, or data centers of a plurality of data centers. The nodes 508 operate similarly to the nodes 150x of system 100 in FIG. 1. Thus, many aspects of the nodes 508 illustrated in FIG. 5 are not repeated.

The system 500 may monitor a plurality of sub-nodes 550a, 550b, 550c (generically referred to as 550) in a cluster, rack, or data center level. The sub-nodes 550 may be components in a device or computer devices in a computing cluster. The plurality of sub-nodes 550 may be connected to corresponding electronic components as previously discussed with respect to the nodes of FIG. 1. Although the system 500 for reactive compute power is illustrated and described as including particular components in a particular arrangement, this disclosure contemplates system 500 including any suitable components in any suitable arrangement.

Clusters are groups of interconnected computers or nodes designed to operate as a single system that shares resources and workload among several servers. Clusters may include high performance computing nodes utilized for performing complex calculations and computations, database clusters for managing data, and web clusters for hosting websites or applications. A server rack may include several computing clusters and a data center may include several server racks include several computing clusters.

In FIG. 5, the nodes 508b and 508c are shown generically as including a CPU 510b and 510c, a power supply 530b and 530c, and nodes 550b and 550c, such peripheral devices. It is understood that these nodes can have any configuration for the particular functional unit. Node 508a is illustrated to include the features as described above with respect to FIG. 1. In other words, aspects of the invention can be combined at different levels, although this is not necessary.

As discussed above, the power provider(s) 502 (and 160 in FIG. 1) could be a local power grid, a microgrid, or other power source (e.g., solar cell, wind turbines, or others). Power providers may include power generated from natural gas, coal, nuclear, solar, tide, and wind, as examples. While not illustrated in the figure, the power provider(s) 502 is the source of power for power distribution units 530 as shown, in one example, in FIG. 1B. Power can be derived from a single source or from different sources, e.g., combined at a local power node (not shown). Each node 508 can receive power from the same source or different sources can provide power to different nodes.

The power provider 502 provides a power-provider signal 522 to the system operation optimization manager 504. The system operation optimization manager 504 is, for example, an independent unit running resource management software. The system operation optimization manager 504 may be implemented as hardware, firmware, or software in a computer server that is distinct from nodes 508. The system operation optimization manager 504 is configured to receive signal 522 indicating the amount of power available at a given time from the power provider(s) 502. In one implementation, the system operation optimization manager 504 coordinates with the system power manager 506 to prioritize a plurality of nodes depending on the job or task to be executed at the node. In another implementation, the system operation optimization manager 504 coordinates with the system power manager 506 to prioritize a plurality of servers.

In this implementation, the power management functions are split between two computing nodes, the system operation optimization manager 504 and system power manager 506 where the former (504) determines power allocations based on availability and the latter (506) implements the power distribution. The use of separate nodes for the purpose of this discussion is understood to not be limiting. The functions described herein can be performed by a single device or distributed amongst any number of devices. FIG. 5 shows just one possible implementation.

When the power available is outside of tolerance, e.g., voltage or current is too high or low for safe server operation, the system operation optimization manager 504 may resort to backup measures or facility wide corrective devices to smooth out power. In a situation where the backup measures or facility wide corrective devices are not available, the system operations optimization manager may shut down downstream nodes.

In certain implementations, when the system operation optimization manager 504 detects a decrease in power available, the system power manager 506 may provide a signal to the low-priority nodes to decrease performance and/or suspend low-priority jobs. When the system operation optimization manager 504 detects an increase in power available, the system power manager 506 may provide a signal to the nodes to increase performance and/or accept additional jobs from the low-priority queue.

In another implementation, the system operation optimization manager 504 may determine when jobs or tasks may be completed with limited power availability. For example, when power availability decreases, the system operations manager may schedule a selective bring up or power down of partitions within the cluster of nodes to correspond with expected changes in power available. The system operation optimization manager 504 may coordinate with the system power manager to concentrate power available to high-priority jobs in the partitions for an expected duration of the jobs and determine which jobs may be sent to a standby queue. The system operation optimization manager 504 may determine a priority amongst the nodes and enable the alternate power source 503 to supply power to the nodes based on the priority of the node.

In another implementation, the system operation optimization manager 504 may determine when jobs or tasks when jobs or tasks may be completed with excess power availability. For example, when power availability increases, the system operations optimization manager 504 may determine a power cap value for the jobs or tasks based on operational policies, then apply the power cap value in an order from low priority to high priority, e.g., the power cap is applied first to low-priority jobs and then to high-priority jobs.

The system power manager 506 is connected to the nodes 508, e.g., to a CPU 510a, 510b, and 510c (generically referred to as 510) that executes an operating system of each node 508, respectively. The operating systems manage hardware resources of the nodes 508 including various tasks such as process management and communication between the servers within the rack and facilitates the execution of various applications and services.

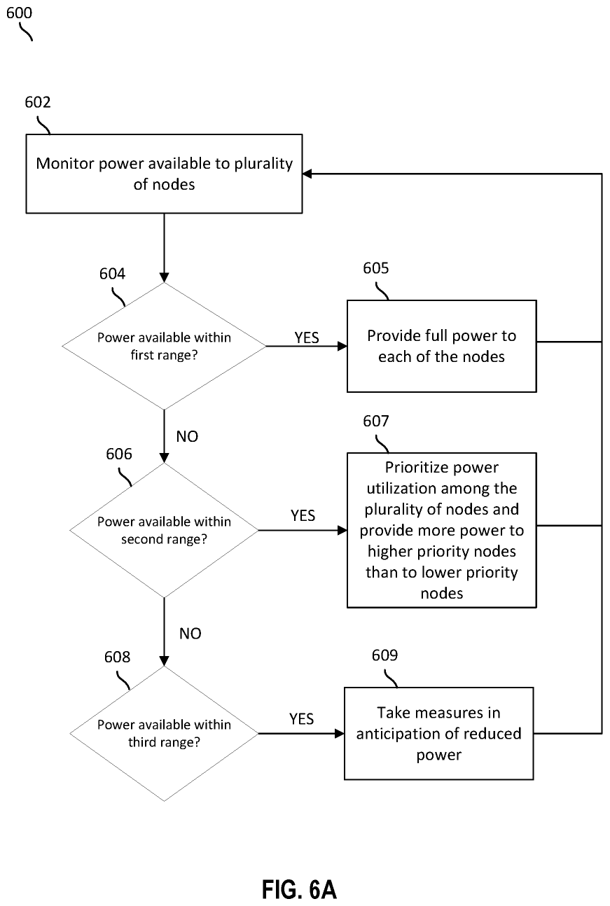

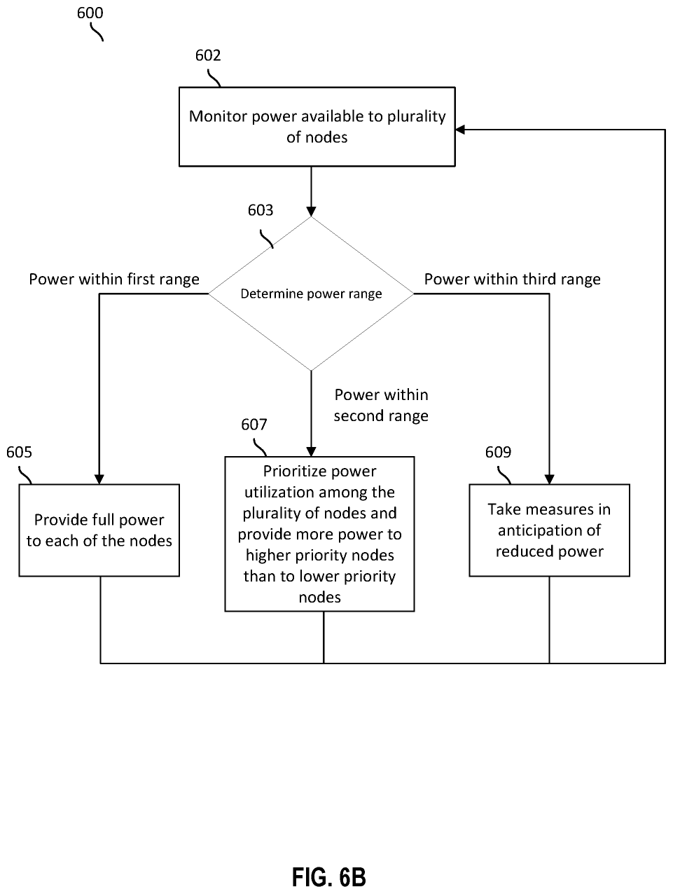

FIGS. 6A and 6B illustrate a method for reactive compute power 600, according to some implementations. The method for providing reactive compute power 600 will be described in conjunction with FIG. 3 and FIG. 5. The method for providing reactive compute power 600 may be performed by the system operation optimization manager 504 and the system power manager 506, or another unit as discussed above.

In step 602, the system operation optimization manager 504 continuously monitors the power available to a system that includes a plurality of nodes. Each of the plurality of nodes may include components in a device, devices in a computing cluster, servers in a server rack, or server racks in a data center. The power available corresponds to an amount of power detected by the power provider 502. The power available may include power generated from natural gas, coal, nuclear, solar, tide, and wind. In monitoring the power available, the system operation optimization manager 504 may determine whether the power available is within a first power range 301, a second power range 302, a third power range 303, or a fourth range 304.

In step 604, the system operation optimization manager 504 determines when the power available is within the first power range 301 above the first threshold and below the third threshold 314. The first threshold 310 is a power range required to operate the node in standard conditions. In step 605, when the power available is within the first power range, the system power manager 506 provides full power to each of the nodes. Full power is a range of power that includes a standard power usage requirement based on the operating voltage of the electronic components required to operate the component.

In step 606, the system operation optimization manager 504 determines when the power available is within a second power range 302 that is below the first threshold 310 and above the second threshold 312. The second threshold 312 delineates a power range in which one or more nodes may operate in a low power setting that is below the power range required to operate the node in standard conditions. In step 607, when the power available is within the second power range 302, the system power manager 506 prioritizes power utilization among the plurality of nodes and provides more power to higher priority nodes than to lower priorities. The priority of the nodes may be based on the jobs or tasks being run, the time sensitivity of the job or task, or the power available to complete the job or task. For example, one node 508a may include high-priority computing tasks and another node 508b may include low-priority computing tasks.

The priority can be determined by the resource manager's policies. As but one example, the Slurm workload manager sets priorities to allow short jobs to run without having to wait more than a few hours, not permit many long jobs to take over the entire cluster for long periods, try to divide the cluster equally among users, and keep all of the cluster's processors as busy as possible all of the time. In other examples, policies may be defined by the system operator (e.g. different job queues with different priorities, or priorities based on users and/or user groups which then get transferred to lunched jobs and associated nodes). A resource manager/workload manager (not shown) could be involved or not depending on a concrete implementation.

As another example, when a first node 508a has a high priority and a second node 508b has a low priority, the system operation optimization manager 504 may transition the second node 508b from full power to reduced power. In some implementations, reduced power may include operating in low power mode when the power available is within the second range. In other implementations, reduced power may include suspending low-priority nodes when the power available is within the minimum voltage tolerance. For example, a CPU may react by operating in a low power mode by throttling down and reducing the workload or decline work units based on the power available when the power available is within the third range. In another implementations, a motherboard cooling control, for example, may react by operating in low power mode by reducing fan speeds.

In step 608, the system operation optimization manager 504 determines when the power available is within the third power range 303. When the power available is within the third power range 303, the system operation optimization manager 504 causes the nodes to take measures in anticipation of reduced power to operate properly. The nodes may engage in backup measures, as shown in step 609. Backup measures may include, but are not limited to, alternate power sources such as uninterruptible power supplies, generators, backup battery systems, microgrids, fuel cell systems, and similar. By engaging in backup measures, the nodes, or selected ones of the nodes, may continue to operate until power is restored by the power provider.

The system operation optimization manager 504 continues to receive a signal 522 from the power provider 502 and monitors the change in power availability in real time. The system operation optimization manager 504 may notify the system power manager 506 in advance when the power-provider signal 522 expects a reduction in power availability. In some implementations, the system power manager 506 may prepare the nodes to complete jobs or tasks that would not be brought down for the expected duration to complete the job or task and begin to take measures in anticipation of reduced power before the power availability changes.

While FIG. 6A illustrates determining the power range according to the power range in steps 604, 606, and 608 sequentially. This sequential nature, however, is not required as illustrated in FIG. 6B, which basically tracks the operations described with respect to FIG. 6A.

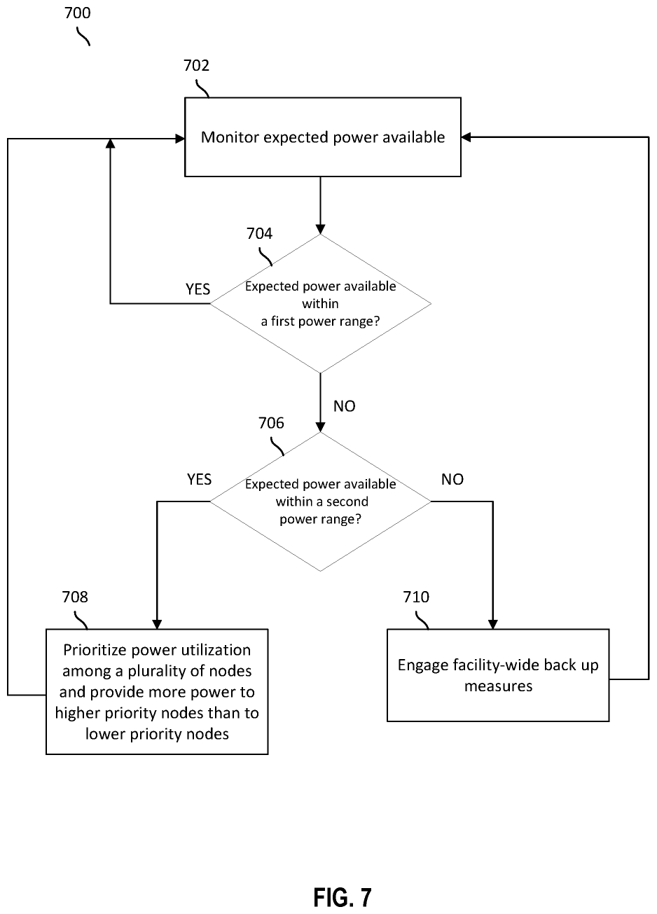

FIG. 7 illustrates a method for reactive compute power 700, according to some implementations. The method for reactive compute power 700 will be described in conjunction with FIG. 5. The method for reactive computer power 700 may be managed by a system operation optimization manager.

In step 702, the system operation optimization manager 504 monitors an expected power availability from a power provider 502. The power provider 502 may provide a signal 522 that includes power grid demand and response information. For example, the power-provider signal 522 may provide a forecast of the power available for a given time interval, e.g., 15 minutes, based on the power demands at the power grid.

In step 704, the system operation optimization manager 504 determines whether the expected power available is within a first power range. In this implementation, the first power range is a range of power that provides the system sufficient power to maintain continued power usage. When the expected power available is outside the first power range, the system operation optimization manager 504 determines whether the expected power available is within a second power range. In this implementation, the second power range is a range of power sufficient to provide power to a portion of the system. When the expected power available is within the second power range, the system operation optimization manager 504 coordinates with a system power manager 506 to prioritize power utilization among a plurality of nodes and provides more power to higher priority nodes than to lower priority nodes. For example, the system power manager 506 may concentrate on high-priority jobs in partitions that would not be brought down for the expected duration of the jobs and determines which jobs can be placed in a standby queue. In another example, the system power manager 506 may concentrate on high-priority jobs and apply power caps to low-priority jobs.

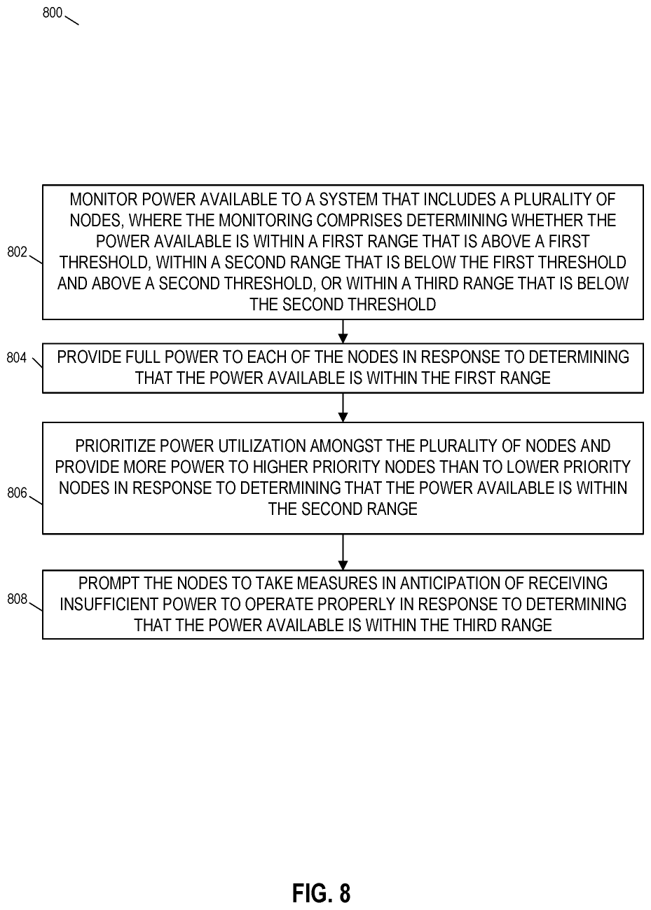

FIG. 8 illustrates a flowchart 800 of a method for reactive compute power, according to some implementations. The flowchart 800 of the method for reactive compute power will be described in conjunction with FIG. 5. The method for reactive compute power illustrated by flowchart 800 may be performed by the system operation optimization manager 504 and the system power manager 506.

In step 802, the system operation optimization manager 504 monitors power available to a system that includes a plurality of nodes 508. The system operation optimization manager 504 determines whether the power available is within a first range that is above a first threshold, within a second range that is below the first threshold and above a second threshold, or within a third range that is below the second threshold.

In step 804, when the system operation optimization manager 504 determines that the power available is within the first range that is above the first threshold, the system power manager 506 provides full power to each of the nodes 508.

In step 806, when the system operation optimization manager 504 determines that the power available is within a second range that is below the first threshold and above a second threshold, the system power manager 506 prioritizes power utilization among the plurality of nodes 508 and provides more power to higher priority nodes than to lower priority nodes.

In step 808, when the system operation optimization manager 504 determines that the power available is within a third range that is below the second threshold, the system power manager 506 prompts the nodes 508 to take measure in anticipation of receiving insufficient power to operate properly.

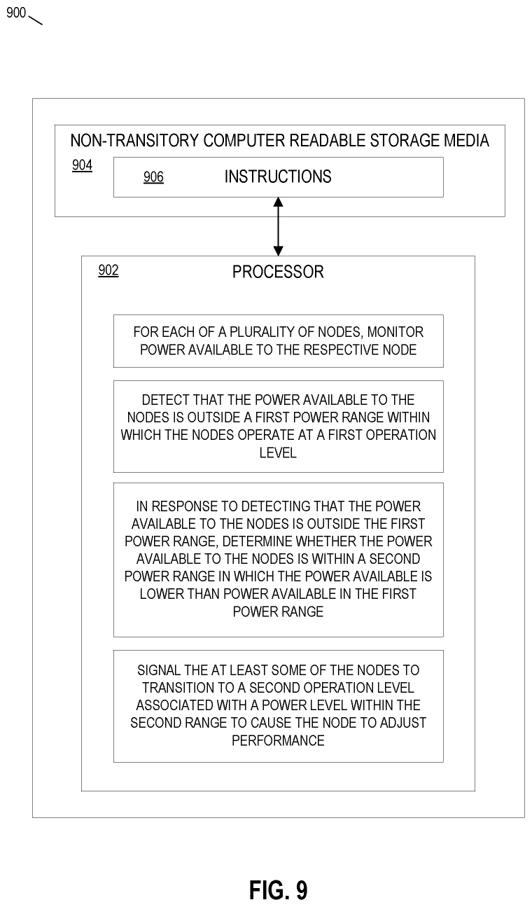

FIG. 9 illustrates a system for reactive compute power 900, according to some implementations. Referring to FIG. 9, the system for reactive compute power 900 includes a processor 902 and a non-transitory computer readable storage media 904 that stores instructions 906 for execution by the processor 902. The instructions 906, when executed by the processor 902, cause the processor to monitor power available to a node corresponding to an electronic component. The instructions 906, when executed by the processor 902, then cause the processor to detect that the power available to the node is outside a first power range within which the node operates at a first operation level. The instructions 1106, when executed by the processor 902, further cause the processor to, in response to detecting that the power available to the node is outside the first power range, determine whether the power available to the node is within a second power range in which the power available is less than the power level in the first power range. The instructions 906, when executed by the processor 902, further cause the processor to signal the node to transition to a second operation level associated with a power level within the second power range to cause the electronic component to adjust performance of the electronic component.

A number of implementations have been described above. It is understood that details described with respect to one of the implementation also apply to the other implementations.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A computer-implemented method, comprising:
monitoring power available to a plurality of nodes, each node corresponding to an electronic component, device, or group of devices;
detecting that the power available to the nodes is outside a power range within which all of the nodes can operate at a full operation level;
in response to detecting that the power available to the node is outside the power range, determining allocation of the available power amongst the nodes; and
in response to the determined allocation, signaling at least some of the nodes to transition to a mode that utilizes less power.

2. The computer-implemented method of claim 1, further comprising, after the signaling, continuing to monitor the power available to the nodes and, in response to detecting that the power available to the nodes is again within the power range, signaling the at least some of the nodes to transition to the full operation level.

3. The computer-implemented method of claim 1, wherein the signaling causes the at least some of the nodes to engage in power reduction measures.

4. The computer-implemented method of claim 1, wherein each node comprises an electronic component of a computer device and the signaling causes the least some of the nodes to adjust performance of one or more electronic component operation parameters, wherein the electronic component operation parameters comprise a clock speed, a voltage parameter, a current parameter, or a cooling parameter.

5. The computer-implemented method of claim 1, wherein each node independently comprises computer devices in a computing cluster, servers in a server rack, or server racks in a data center.

6. The computer-implemented method of claim 1, further comprising determining a priority amongst the nodes and enabling an alternate power source to supply power to the nodes based on the priority of the node.

7. The computer-implemented method of claim 1, wherein monitoring the power available is continuous and wherein signaling the electronic component to adjust performance of the electronic component is substantially instantaneous.

8. A computer-implemented method comprising:
monitoring power available to a system that includes a plurality of nodes, wherein the monitoring comprises determining whether the power available is within a first range that is above a first threshold, within a second range that is below the first threshold and above a second threshold, or within a third range that is below the second threshold;
in response to determining that the power available is within the first range, providing full power to each of the nodes;
in response to determining that the power available is within the second range, prioritizing power utilization amongst the plurality of nodes and providing more power to higher priority nodes than to lower priority nodes; and
in response to determining that the power available is within the third range, prompting the nodes to take measures in anticipation of receiving insufficient power to operate properly.

9. The computer-implemented method of claim 8, wherein providing more power to higher priority nodes comprises keeping the high-priority nodes at full power and providing low power to the low-priority nodes.

10. The computer-implemented method of claim 8, wherein providing more power to higher priority nodes comprises providing power sufficient for the higher priority nodes to continue to operate and causing the low-priority nodes to suspend operation.

11. The computer-implemented method of claim 8, wherein each node independently comprises:
computer devices in a computing cluster;
servers in a server rack; or
server racks in a data center.

12. The computer-implemented method of claim 8, wherein each node comprises a component of a computer device.

13. The computer-implemented method of claim 8, further comprising, in response to determining that the power available is within the second or third range, enabling an alternate power source to supply power to the nodes.

14. The computer-implemented method of claim 8, wherein the measures taken in anticipation of receiving insufficient power to operate properly comprises suspending operation of the nodes.

15. A system, comprising:
one or more processors and
one or more non-transitory computer readable storage media storing programming for execution by the one or more processors, the programming comprising instructions to:
for each of a plurality of nodes, monitor power available to the respective node;
detect that the power available to the nodes is outside a first power range within which the nodes operate at a first operation level;
in response to detecting that the power available to the node is outside the first power range, determine whether the power available to the nodes is within a second power range in which the power available is lower than power available in the first power range; and
signal the at least some of the nodes to transition to a second operation level associated with a power level within the second range to cause the node to adjust performance.

16. The system of claim 15, the programming further comprising instructions to, after the instruction to signal, continue to monitor the power available to the nodes and, in response to detecting that the power available to the nodes is within the first power range, signal the nodes to transition to the first operation level.

17. The system of claim 15, the programming further comprising instructions to determine whether the power available is within a third power level in which the power available is lower than the power available in the second power range and, in response to determining that the power available is within the third power level, signal each the nodes to take measures in anticipation of receiving insufficient power to operate properly.

18. The system of claim 15, further comprising instructions that enable an alternate power source to supply power to the node in response to detecting that the power available to the node is outside the first power range.

19. The system of claim 15, wherein node comprises an electronic component and the instruction to signal causes the node to adjust performance of one or more electronic component parameters, wherein the electronic component parameters comprise a clock speed, a voltage parameter, a current parameter, or a cooling parameter.

20. The system of claim 15, wherein monitoring the power available is continuous and wherein signaling the electronic component to adjust performance of the electronic component is substantially instantaneous.
